(19) United States
(12) Patent Application Publication
(10) Pub. No.: US 2014/0052495 A1
(43) Pub. Date: Feb. 20, 2014

(54) Systems and methods for determining if change events affect viewership

(71) Applicant: Evan Davis, Beaverton, OR (US)

(72) Inventor: Evan Davis, Beaverton, OR (US)

(21) Appl. No.: 13/587,707

(22) Filed: Aug. 16, 2012

(51) Int. Cl. G06Q 30/02

(52) U.S. Cl. CPC G06Q 30/0201
USPC 705/7.29

(57) ABSTRACT

Elements of a document that can affect viewership are identified, monitored and recorded as change events. The numbers of computers, individuals or others viewing a publication (viewers) and what times they viewed it are collected from the appropriate source for the medium. One or more groups of change events for a given period of time are compared to the corresponding viewers via statistical regression to determine how much a given set of change events affects the changes in total viewers.

### TECHNICAL FIELD

This invention relates to the collection, classification and correlation of document changes, more specifically as it relates to individual interaction with those documents, the frequency thereof as well as the affects this might have on related document indexing systems.

### BACKGROUND OF THE INVENTION

The internet has allowed commerce a new channel to gain revenue. The expansion of the World Wide Web has businesses relying more and more upon revenues generated through their web pages. These revenues are dependent upon people visiting their websites and purchasing products there. If a business can increase the number of people visiting their website it often follows that more products are then sold on that website. This has created an industry devoted to increasing the number of visitors to websites sometimes referred to as Inbound Marketing.

To increase the number of visitors Inbound Marketers have relied on trial and error to achieve success. In most cases there are no real measurements that tell them if a specific action is successful other than a general increase in traffic. If a correlation method is used, they are reminded that correlation is not causation and they are left with general measurements to decide if their tactics are working. The need then becomes: how to create meaningful cause and effect measurements that show if the changes made actually affect the number of visitors to a website?

### BRIEF DESCRIPTION OF DRAWINGS

FIG. 1 Is a flow chart showing general methods & systems.

FIG. 2 Is a flow chart covering the acquisition of change events.

FIG. 3 Is a flow chart covering the acquisition of visitor data.

FIG. 4 Is a flow chart showing the correlation of change events vs. visitor data.

FIG. 5 Is a flow chart showing the differences added by Claim 2.

### DETAILED DESCRIPTION

This invention is meant to solve the lack of meaningful measurements for document changes and how they affect the number of visitors to that document. In order to build a system to achieve the object of this invention it adopts the means of a server device consisting of a processor, storage device and input/output connections (computer). The systems and methods described hereafter are assumed to be executed by one of these devices (computers). The end product is a useful, automated system that will reduce the number of man hours required to analyze and understand the effectiveness of inbound marketing.

There are three major components of the automated process being identifying change events, gathering visitor traffic data and correlating the findings.

Step one involves defining what elements will be tracked for a given document. This can change from document to document, but can include any element in the document that might change at some future date. Some examples include title, description, headings, paragraphs, images, references and other document elements that can be defined. The elements to be tracked are extracted from the document, sorted by type of element and stored in a database. The document is then monitored for changes to any of the tracked elements. When a change is detected the element, the date and time of the detected change are stored as a change event.

Step two gathers data on the number of visitors that view the document over a period of time that includes the change events. This data can be obtained from many different sources and it does not matter which source is chosen, only that the all the sources parameters for defining visitors remain the same for the full time period the change events cover. The traffic is split into smaller, regular time segments showing the number of visitors per period. For example visitors per month, visitors per day, visitors per hour, etc. This information can be stored temporarily or permanently as the situation requires.

Step Three uses the data from steps one and two. The change events are converted to number of change events per time period to match the time period from the visitor data. So if the visitor data is number of visitors per day the corresponding data would be number of change events per day. This data, for a specific range of time, is then correlated using statistical regression to determine how much the change events affect the number of visitors. The correlation coefficient, intercept, range of time, time period, change event type and the confidence interval are recorded in a database.

The information created by this process can be displayed, sent to another system or printed out for use.

The process can be modified by adding in the means by which a visitor became aware of the document.

This would be a visitor traffic source. If a visitor traffic source has means to become aware of changes to the document and this awareness is detectable then it is possible to get a more accurate result from step three. This is achieved by recording the change event as outlined above, detecting when a source becomes aware of the change event, recording the source and date it became aware of the change. Use this information in executing step three by replacing the change event date with the source awareness date before converting the change events into number of change events per time period. The visitor traffic would also need to be limited to visitors that were referred by the source for this to work.

Change events can use elements that are not part of the document. These elements need to be related to the document in some way and can be reliably tracked. These can then replace standard change events and yield similar correlation results.

The process can also be modified by monitoring external factors that can affect the number of visitors to a document. These external factors can include the number of sources that can make visitors aware of a document, what those sources say about the document (bad or good) or any other external factor. If these external factors can be identified, defined and their changes can be tracked then it is possible to use them in the primary method above. External factors can be defined as external change events and they can be substituted for the change events in step one, producing similarly useful results.

### BEST MODE FOR CARRYING OUT THE INVENTION

### Embodiment 1

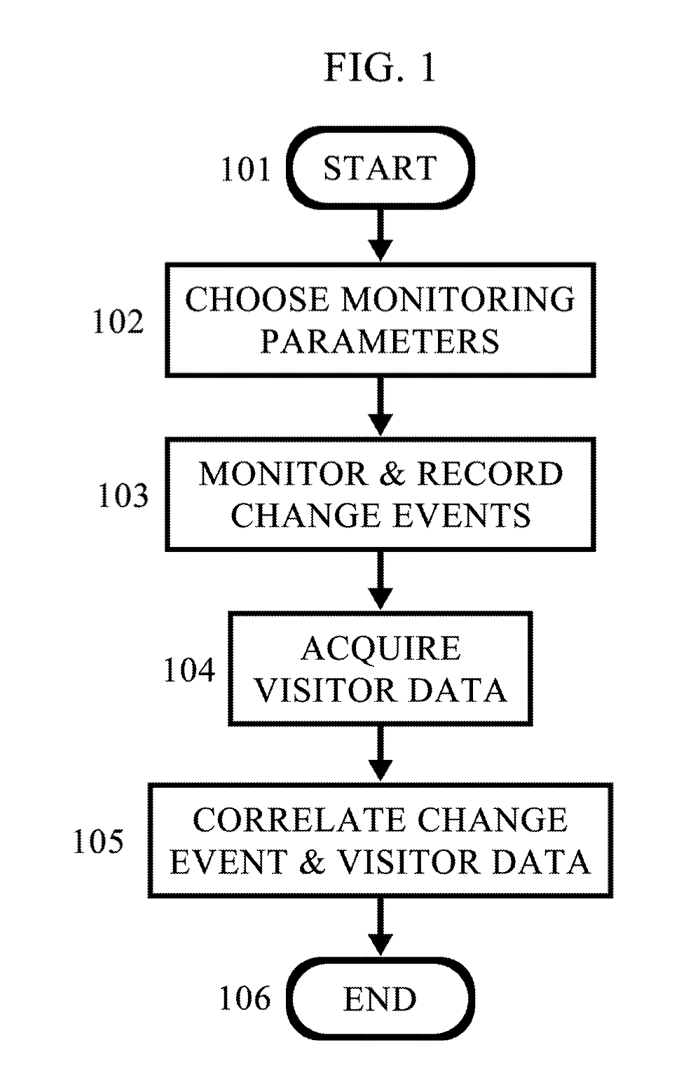

FIG. 1 shows a general description of the overall process for the systems and methods for determining if change events affect viewership. Once created this system will require input about what document elements will be monitored determined in 102. These identified elements will then be indexed and monitored for changes in 103 which are then recorded. Information about viewers of the document is obtained from an outside source in 104 and indexed. The data from 102 & 103 is then correlated using regression analysis to determine the effects of the change events on the visitors for a specific document.

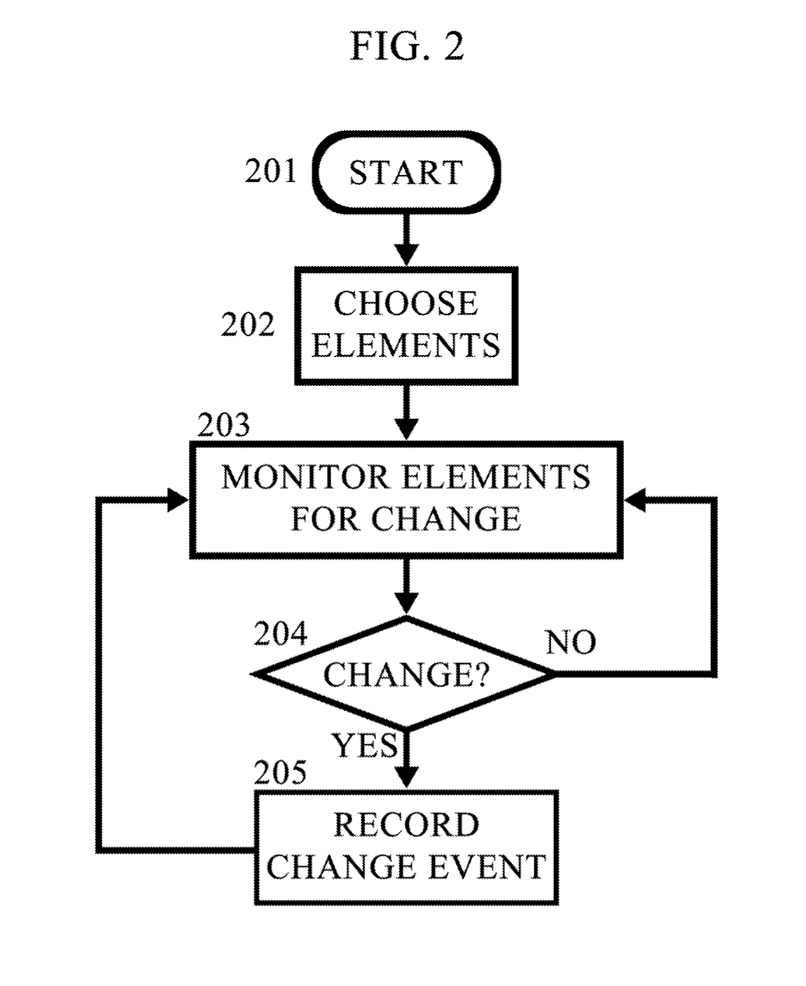

In FIG. 2 the parameters of 102 determine what elements are selected in 202. 203 first involves recording the existing data that will be monitored. Monitoring of the element involves checking the current element to the one recorded in the index. At each check of the document in 204, if there is no change then monitoring continues. When a change is detected in 204 it is recorded as a change event in 205 as part of the index and the same change event will be used as the new base for comparison for the subsequent 204 check.

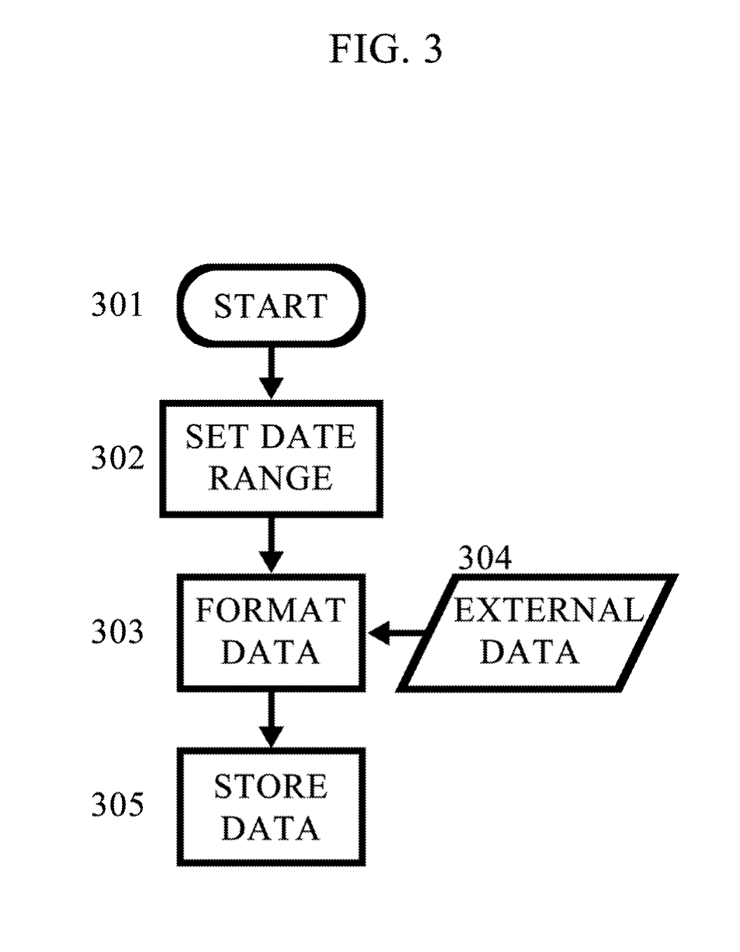

In FIG. 3 information about viewers of a document are recorded by an outside entity using whatever methods they have developed outside this system. In 302 the date range is then set for the viewer data to be retrieved. The data is then retrieved via 304 and formatted in 303 to the time delimiter set by the user in 302. This could be viewers per day, viewers per year, etc. This data is then stored, either temporarily or permanently, in 305.

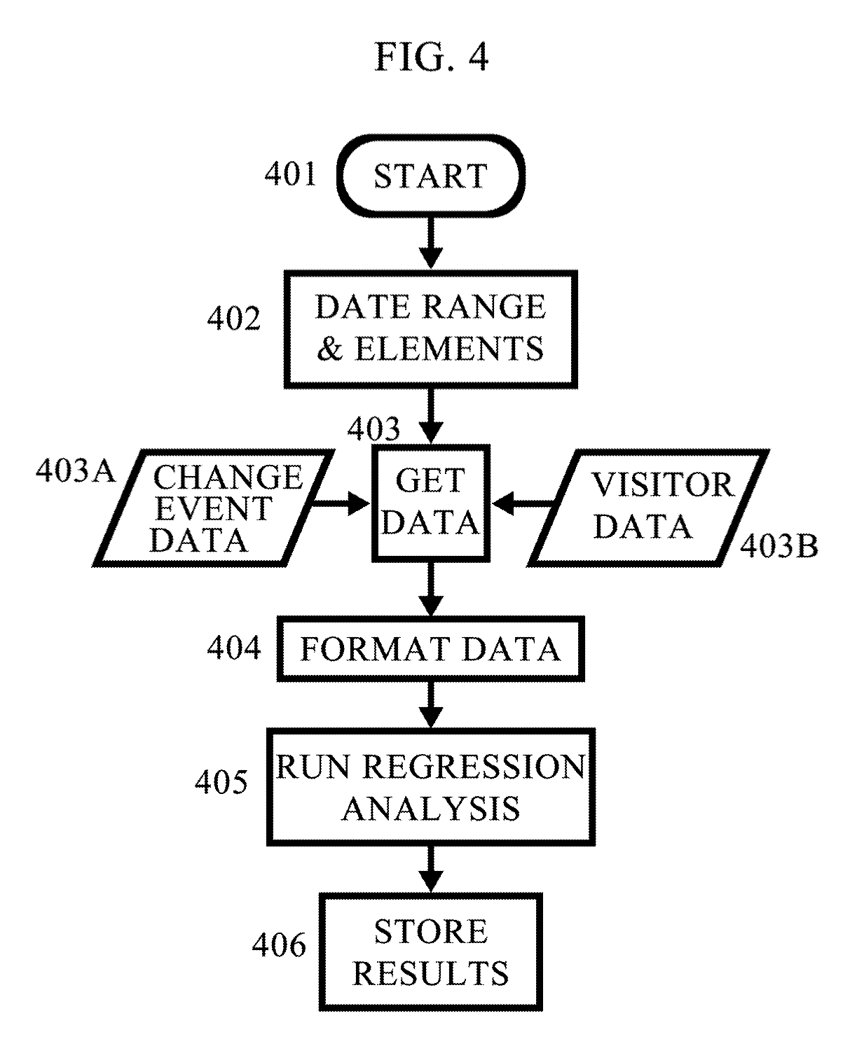

FIG. 4 then takes the element and date range set by the user in 402 to get the data in 403 from the change event index/403A and the visitor data/403B. This data is then formatted in 404 to be processed in a regression analysis in 405.

### Embodiment 2

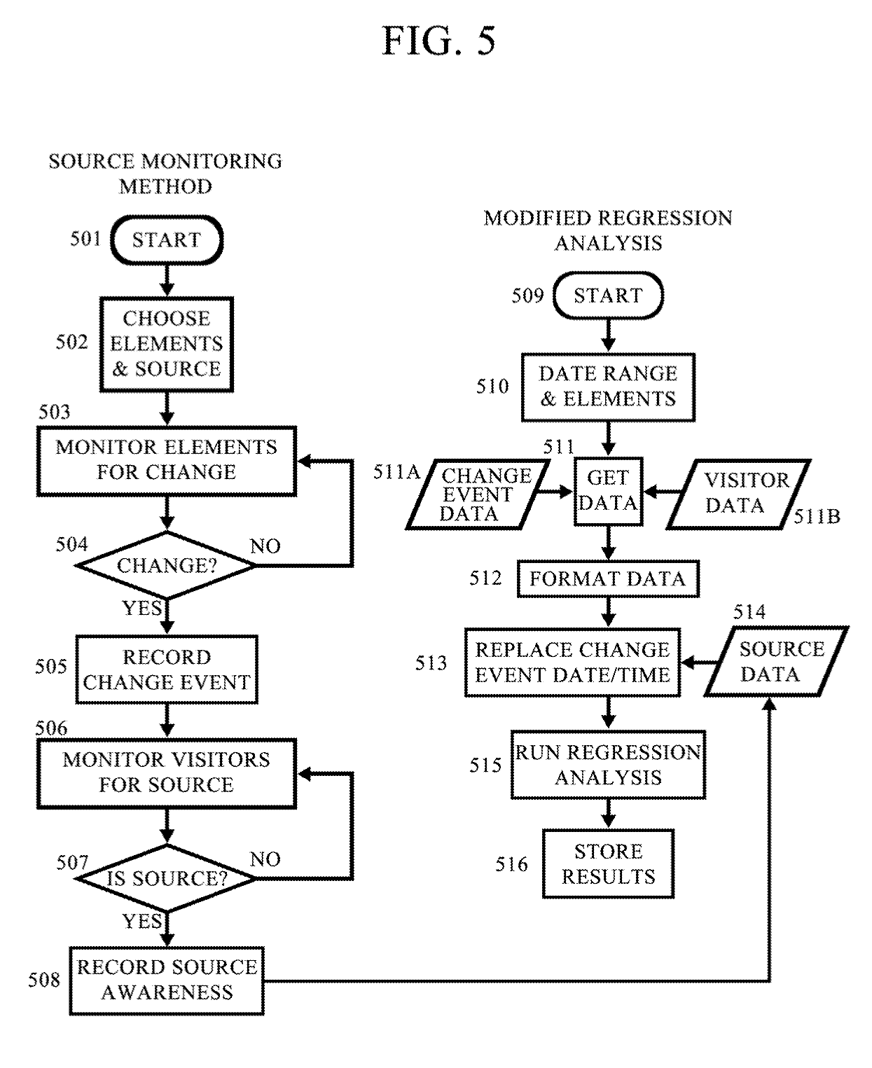

FIG. 5 shows a similar process to Embodiment 1 where FIG. 1 & FIG. 2 are the same. FIG. 5 has a process by which a source (a source is the means by which the viewer followed to view a document) to be monitored is selected 502 and then steps 503, 504, and 505 are run just like steps 203, 204, and 205 from FIG. 2. After 505 viewers of the document are then monitored in 506 to see when the source becomes aware of the change in 507. If the source is detected the date and time the source became aware of the change event is recorded in 508 and stored in 514. The regression analysis in 509-516 is similar to steps 402-406 in FIG. 4 except the steps 513 and 514 are inserted between 404 and 405. After the data is formatted in 404 the date the source became aware of the change event is substituted for the date of the change event for each change event in 513. This new data set would then be correlated using regression analysis in 514.

### Embodiment 3

Similar to Embodiment 1 this includes all the components from FIG. 1, FIG. 2, FIG. 3 and FIG. 4. The change is made when dealing with 202 and 203 where the elements to be monitored are not a component, format or attribute of the document. The element chosen in 202 should be related to the document being correlated against in some way (a reference, referral, fame, arbitrary measurement, etc.) and can be obtained through an external method or system. When a change is detected in 203 for the external element it is recorded as a change event. Otherwise, all other methods will work the same.

1. A method where regression analysis is used to correlate change events on a document with traffic to that document for a given period of time, where:
change events are the time and date of changes in elements on a web page that are able to change, and elements on a web page include content viewable by visitors, elements not visible to visitors, html tags, programming scripts retained in the viewed document, meta data contained in the document and separate files, images, graphics, videos, audio or documents that are displayed as part of the document;
traffic is the total number of viewers viewing or interacting with the document for a given period of time where viewers include persons, computers, servers and devices able to view documents, and viewing or interacting with the document is using methods including a web browser, document viewer, mobile device, computer programs or devices to view information that is delivered as part of the document;
and regression analysis is a mathematical comparison process using linear, simple linear, logistic, nonlinear, nonparametric, exponential, quadratic, binary, multiple, robust, stepwise, or multivariate regression to determine correlation between sets of data.

2. The method of claim 1, further comprising:
determining and recording the times and dates a source of traffic becomes aware of the change events for a document to replace the times and dates of change events in the regression analysis of claim 1, where a source of traffic is the means by which the viewer was directed to the document which includes search engines, other documents, advertisements, other websites and direct navigation where the time and date the source became aware of the change event can be determined.

3. The method of claim 1, further comprising:
determining and recording external change events to use instead of change events in the regression analysis of claim 1, where external change events are elements not part of the document that can change in a way that can be measured, can affect the number of viewers of the document, and the time and date of change can be determined.
